(19) United States
(12) Patent Application Publication
(10) Pub. No.: US 2019/0334277 A1
(43) Pub. Date: Oct. 31, 2019

(54) DEVICE FOR CONNECTING CONDUCTORS AND CONNECTION ASSEMBLY COMPRISING SUCH A DEVICE

(71) Applicant: Safran Aerosystems, Plaisir (FR)

(72) Inventors: Yannick Pelletier, Plaisir (FR); Fabrice Brajard, Plaisir (FR)

(73) Assignee: Safran Aerosystems, Plaisir (FR)

(21) Appl. No.: 16/349,949

(22) PCT Filed: Nov. 10, 2017
(86) PCT No.: PCT/EP2017/078910

§ 371 Date: May 14, 2019

(30) Foreign Application Priority Data
Nov. 18, 2016 (FR) 1661219

(51) Int. Cl. H01R 13/512; H01R 13/6599

(52) U.S. Cl. CPC H01R 13/512; H01R 13/6599

(57) ABSTRACT

This device for connecting conductors, in particular electrical conductor cables or optical fibres, comprises a hollow body (3) defining an inner passage (P) for the conductors and an attachment member (5) for attaching the body onto a connector (4). The device comprises a removable spacer (6) that can be positioned in the extension of the body, between the body and the connector, the spacer internally defining a chamber opening on either side of the spacer at mutually opposite faces and intended to interact with the hollow body and/or the connector, the spacer being able to be opened in such a way as to allow access to the chamber.

The present invention relates in general to devices for connecting conductors. Such devices may for example be used for connecting electrically conducting cables, for example comprising a bundle of conductors, or for connecting optical fibers.

Such a device, in a nonlimiting application of the invention, may be used for connecting conductors of an aircraft onboard data transmission network or power supply network.

Conductor connecting devices generally comprise a hollow body, which is mounted around a sheath of a first bundle of conductors, and means for fixing the hollow body to a connector which connects the conductors of the first bundle to the conductors of a second bundle that is to be paired therewith.

On mounting, or during the course of maintenance operations, for example when changing cables or connectors, it is necessary to provide enough length of cable to allow the cables to be manipulated and connected to the connector, without impairing the protection of the cables.

This problem manifests itself all the more acutely when the connecting device is used for connecting cables of short length, for example of a length less than 500 mm, or when connecting cables that are relatively rigid, for example made of copper or of aluminum, or cables of relatively high cross section, for example of at least 1.8 mm, which are difficult to bend. This problem also arises when connecting optical fibers which are unable to tolerate curvatures with a relatively small radius of curvature.

In order to be able to have sufficient length of cable available, a wiring chamber, analogous to a junction box, is sometimes provided, this being sited in the middle portion of the cables and housing an additional length of cable.

However, when the issue is one of connecting optical fibers or rigid cables, of short length or large cross section, which will not fit into a wiring chamber unless such a wiring chamber is excessively oversized, this solution is unsuitable because of the space it occupies and because of the difficulty in implementing it.

It is therefore an object of the invention to alleviate the aforementioned disadvantages and to propose a conductor connecting device that is able to house a length of cable necessary for the wiring.

A first aspect of the invention therefore relates to a connecting device for conductors, notably for electrically conducting cables or optical fibers, comprising a hollow body internally delimiting a passage for the conductors and a member for fixing the hollow body onto a connector of the connecting device.

This coupler further comprises a removable spacer able to be positioned in the continuation of the body, between the body and the connector, the spacer internally delimiting a chamber opening onto each side of the spacer via mutually opposing faces which are intended to collaborate with the hollow body and/or with the connector, the spacer being able to be opened up in order to permit access to said chamber.

Thus, the spacer constitutes an element of the conductor connecting device which surrounds a length of cable which may advantageously be manipulated when the spacer has been removed.

For example, the spacer comprises a set of at least two shells, notably in the form of a truncated cylinder, designed to be assembled to form a cylindrical ring segment.

Each shell may comprise a peg that engages in a hole made in another shell, and a hole that accepts the peg of said other shell.

Advantageously, at least one of the mutually opposite faces of the spacer is toothed so as to collaborate with a toothset formed in the body and/or in the connector.

This feature is advantageous when the member for fixing the body to the connector comprises a nut, the toothsets preventing the spacer from turning with respect to the hollow body and/or with respect to the connector, as the nut is tightened.

When the fixing member comprises a nut, this nut is advantageously mounted slidingly with respect to the hollow body and comprises a screw thread able to collaborate with a complementary screw thread of the connector.

This nut preferably comprises a shoulder able to come to bear on an end stop of the hollow body.

In one embodiment, the hollow body has an elbowed shape.

In one embodiment, of the fixing member, the hollow body and the spacer, at least one is made from a metallic material or from a metal alloy, such as a stainless steel.

As an alternative, of the fixing member, the hollow body and the spacer, at least one is made from a material comprising a polymer, which may notably be a polyether ether ketone (PEEK), filled with particles of at least one metal or coated with said metal.

According to a second aspect, another subject of the invention is also a connection assembly for conductors, notably electric cables or optical fibers, characterized in that it comprises a connecting device as defined hereinabove and a connector able to collaborate with said connecting device.

Further objects, features and advantages of the invention will become apparent from reading the following description, given solely by way of nonlimiting example, and made with reference to the attached drawings in which:

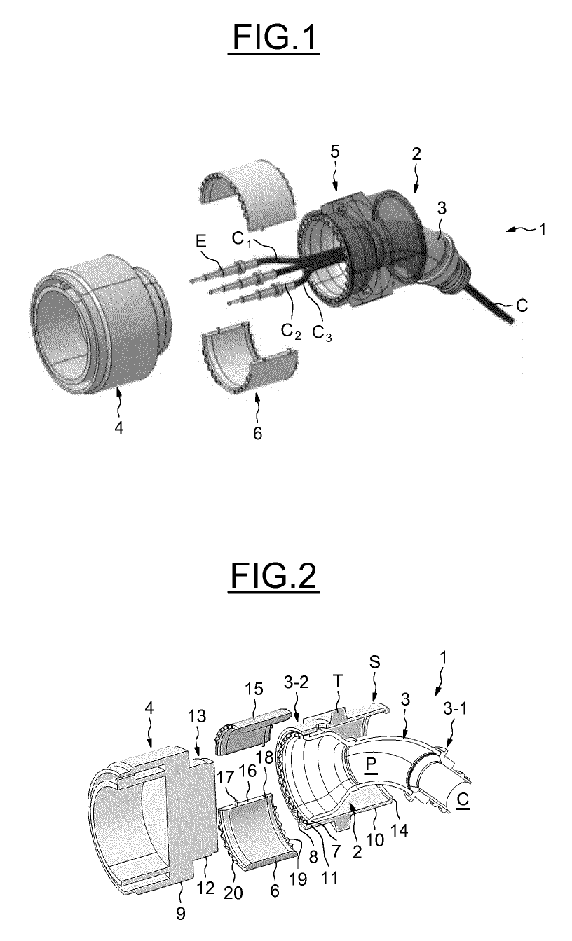

FIG. 1 is an exploded view of a conductor connecting device according to the invention;

FIG. 2 is a view in longitudinal section of the device of FIG. 1;

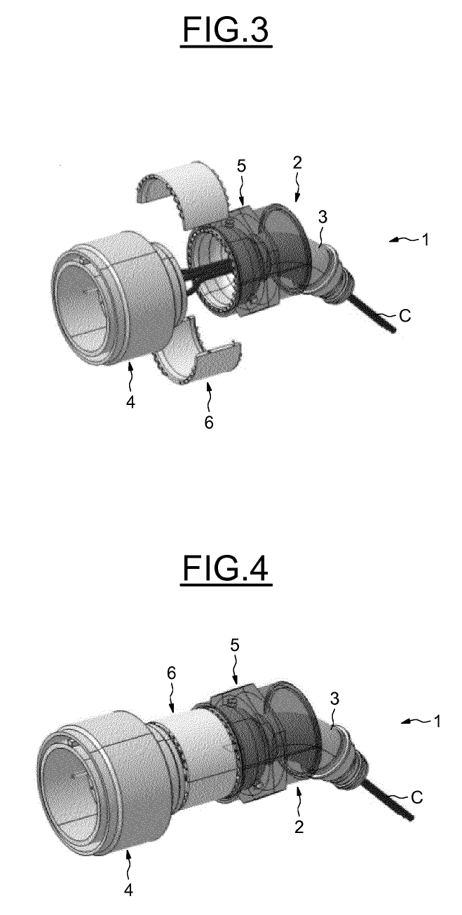

FIG. 3 shows the device of FIG. 1 when connecting conductors using the connector;

FIG. 4 illustrates the conductor connecting device during the fitting of the shells;

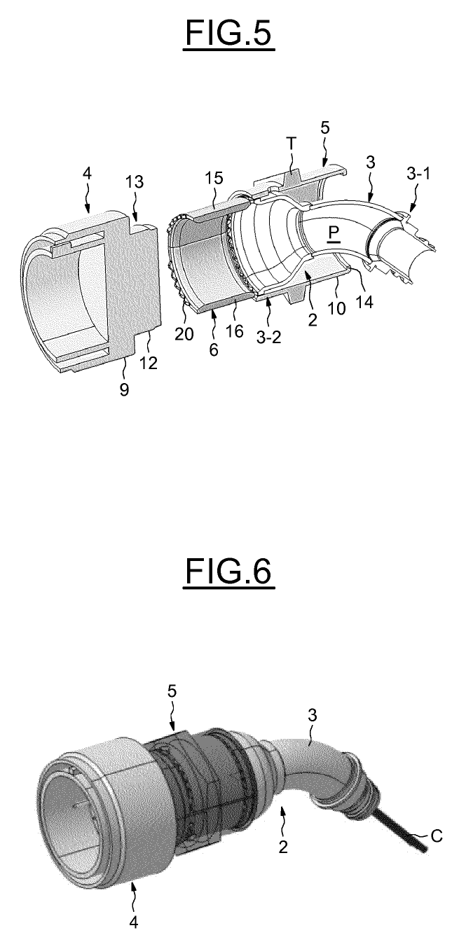

FIG. 5 is a view in longitudinal section of the connecting device during the fitting of the shells;

FIG. 6 shows the conductor connecting device after the nut has been tightened; and

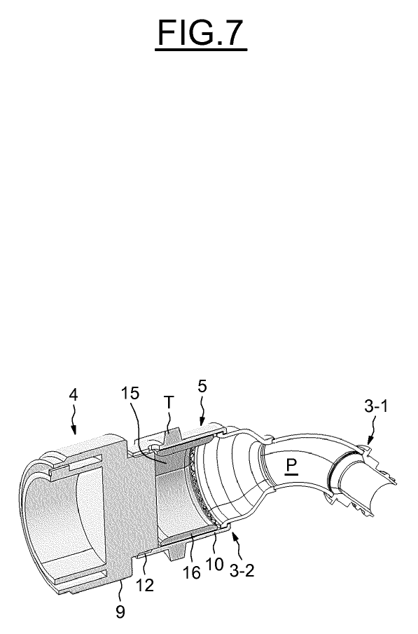

FIG. 7 is a view in longitudinal section of the device of FIG. 6.

Reference will be made first of all to FIGS. 1 and 2 which illustrate a conductor connecting device according to the invention, denoted by the general numerical reference 1.

This device is intended for connecting conductors, such as electrically conducting cables or a bundle of optical fibers.

In the exemplary embodiment illustrated, the device 1 is used to connect a bundle of cables C, in this instance comprising three cables C1, C2, and C3, with a bundle of corresponding cables (which has not been depicted) which are to be paired therewith. For this purpose, the cables C1, C2, and C3 are provided at their end with contact end fittings E, in this instance male contact end fittings, for example crimped on, intended to collaborate with female contact end fittings provided at the respective ends of the cables that are to be paired therewith.

The connecting device 1 comprises a hollow body 3; a member 5 for fixing onto a connector 4 in which the crimped male contact end fittings and the female end fittings of the conductors that are to be paired therewith plug together, and a spacer 6 which is interposed between the device 1 of the invention and the connector 4.

As can be seen, the body 3 is hollow so that it delimits an internal passage P for the bundle of cables C and comprises a proximal first portion 3-1, typically of tubular shape, notably secured to the protective sheath of the bundle of cables C, and a distal portion 3-2, which may be of divergent shape, via which the cables C1, C2 and C3 emerge to the outside of the device 1 of the invention.

The shoulder may be of continuous shape, such as of substantially annular shape as here, or alternatively may be made up of a discrete element or of circumferentially distributed distinct elements.

At its free end, the distal portion 3-2 comprises an annular shoulder 7 against which the fixing member 5 comes into abutment.

The end edge face of the distal portion 3-2 may comprise an annular toothset 8 which, as will be described in detail later on, collaborates with a corresponding toothset in one of the mutually opposite faces which are intended to collaborate with the hollow body 3 and/or with the connector 4 of the spacer 6.

In the exemplary embodiment depicted, the proximal portion 3-1 is substantially elbowed. Specifically, the proximal end 3-1 is configured according to the desired orientation for the bundle of cables leaving the device of the invention. The angle made by the elbow may for example be comprised between 45° and 90°. It would not constitute a departure from the scope of the invention if this tubular end were substantially straight.

The connector 4 also comprises a base 9 which comprises a collection of passages in which the end fittings E crimped onto the ends of the cables C1, C2, C3 engage and into which the female contact end fittings provided at the ends of the cables that are to be paired therewith engage.

The member 5 for fixing the body onto the connector 4 is produced in this instance in the form of a nut comprising a cylindrical body 10 comprising a distal end 11 provided with an internal screw thread which collaborates with a complementary screw thread 12 made on a proximal end 13 of the connector, and a proximal shoulder 14 which, on tightening, comes to bear against said shoulder 7. The nut is provided with a central head T which is polygonal or of any other type of suitable shape so that it can be tightened using an appropriate wrench.

Finally, FIGS. 1 and 2 show that the spacer 6 has a cylindrical overall shape.

It comprises a set of shells, notably in the form of truncated cylinders, which are intended to be assembled in order to form a cylindrical ring segment.

In the exemplary embodiment depicted, the spacer 6 comprises two semicylindrical shells 15 and 16.

The longitudinal edges of said shells may be provided with a pin 17 and with a hole 18 which are respectively intended to engage in a hole and to accept a pin belonging to the other shell.

In an alternative form, the shells may collaborate via a slideway.

It is also possible to produce the spacer in the form of a single cylinder produced from articulated semicylindrical portions capable of being opened in order to provide a lateral opening of the spacer.

As indicated previously, that face of the spacer 6 that faces toward the hollow body 3 is provided with a toothset 19 collaborating with the toothset 8 of said body.

The opposite face of the spacer is also provided with a toothset 20 which, through having complementary shapes, collaborates with a corresponding toothset made at the proximal end of the connector 4.

As indicated previously, the nut 5 is assembled around the hollow body 3.

More specifically, it is mounted slidingly with respect to the nut so as to adopt a retracted position, visible in FIGS. 1 and 2 allowing the spacer to be removed in order to gain access to a length of cable between the hollow body and the connector and a forward position in which the nut is screwed onto the screw thread 12 of the connector.

Specifically, with reference to FIG. 3, when the nut 5 is in the retracted position, the shells 15 and 16 of the spacer can be parted by opening them up laterally with respect to the conductors plugged into the connector, thereby freeing up a space between the device of the invention and the connector to make the conductors easier to manipulate. In other words, the spacer makes it possible to delimit a space in which a sufficient length of cable to allow the cables to be connected can be housed.

The spacer 6 thus internally delimits a chamber 20 open on each side of the spacer and opening to open up the spacer laterally, this chamber further constituting a volume in which an additional length of cable may, if appropriate, be coiled.

This chamber can also be used to house components or elements provided at the ends of the cables C1, C2 and C3 that are to be coupled, such as extensions or components of the self-soldering type, which cannot be housed inside the protective sheath or which need to be positioned as close as possible to the connector in order to limit disturbances and the risks of damage.

After this operation of connecting the cables, the shells are assembled once again (FIGS. 4 and 5), then the nut is moved translationally around the shells so that it can be tightened onto the screw thread 12, until such point as the shoulder 14 of the nut comes into abutment against the shoulder 7 of the coupler.

The connecting device is then in the position visible in FIG. 6.

As may be imagined, the invention which has just been described, which uses a spacer and a nut capable of translational movement in order to free the spacer makes it possible, once the spacer has been opened and removed, to gain access to a length of cable that allows the bundle of cables to be connected to the connector.

According to an alternative form, a nut that moves in a different movement, such as a rotation, may be used.

It will be noted that the invention is not restricted to the embodiment described and that other alternative forms may be conceived of.

For example, the length of the spacer may be comprised between around 18 mm and 35 mm, but may reach a length of the order of 60 mm.

In various embodiments, the hollow body, the spacer and the nut may be made of metal, or of metal alloy, such as stainless steel.

The nut, the hollow body and the shells of the spacer may also be made of composite material, using a polymer such as polyether ether ketone or “PEEK” filled with metal particles or coated with a metallized layer.

This is because the use of a metallic material or of a metal alloy or the use of a composite material filled with metallic particles or coated with a metal is advantageous insofar as it makes it possible to produce a connecting device that provides shielding against electromagnetic disturbances.

1. A connecting device for conductors that are electrically conducting cables or optical fibers, the connecting device comprising a hollow body (3) internally delimiting a passage (P) for the conductors and a member (5) for fixing the hollow body (3) onto a connector (4), wherein the device further comprises a removable spacer (6) configured for positioning in the continuation of the body, between the body and the connector, the spacer internally delimiting a chamber (20) opening onto each side of the spacer via mutually opposing faces that collaborate with the hollow body or with the connector, wherein the spacer (6) is configured for opening up when permitting access to said chamber (20).

2. The connecting device as claimed in claim 1, in which the spacer (6) comprises a set of at least two shells (15, 16), in the form of a truncated cylinder, wherein the at least two shells are configured for assembling to form a cylindrical ring segment.

3. The connecting device as claimed in claim 2, wherein each shell comprises a peg (17) that engages in a hole (18) of other shell, and a hole that accepts the peg of said other shell.

4. The connecting device as claimed in claim 1, wherein at least one of the mutually opposite faces of the spacer is toothed to collaborate with a toothset (8) formed in said body or in said connector.

5. The connecting device as claimed in claim 1, in which the fixing member comprises a nut mounted slidingly with respect to the hollow body, the fixing member further comprising a screw thread configured to collaborate with a complementary screw thread (12) of the connector.

6. The connecting device as claimed in claim 5, wherein the nut comprises a shoulder (14) configured to bear on an end stop (7) of the hollow body.

7. The connecting device as claimed in claim 1, wherein the hollow body comprises an elbowed shape.

8. The connecting device as claimed in claim 1, wherein at least one of the fixing member (5) at least one of the hollow body (2) and the spacer (6) is made from a metallic material or from a metal alloy.

9. The connecting device as claimed in claim 1, wherein at least one of the fixing member (5), the hollow body (3) and the spacer (6), is made from a material comprising a polymer filled with particles of at least one metal or being coated with said metal.

10. A connection assembly for conductors, comprising a connecting device of claim 1 and a connector configured to collaborate with said connecting device.
